(19) United States
(12) Patent Application Publication
(10) Pub. No.: US 2008/0171307 A1
(43) Pub. Date: Jul. 17, 2008

(54) Unique system for constructing dental implant crowns and bridgework utilizing pre-fabricated parts

(75) Inventor: William Gary Wilcox, Glastonbury, CT (US)

Correspondence Address: Nancy L. Moskow, 26 Portland Road, Marlborough, CT, 06447, US

(73) Assignee: Inventions Capitalized, Inc

(21) Appl. No.: 12/007,177

(22) Filed: Jan. 8, 2008

Related U.S. Application Data
(60) Provisional application No. 60/879,355, filed on Jan. 9, 2007.

(51) Int. Cl. A61C 5/09

(52) U.S. Cl. 433/222.1

(57) ABSTRACT

This is a system of prefabricated components of various materials that are physically, chemically and structurally compatible with one another and with various esthetic veneering materials used in the fabrication of fixed dental restorative and prosthetic devices. Due to the considerable expense and time generated by using external laboratories, there exists a need to provide a system for the production of non-metallic crown and bridge understructures utilizing, to the greatest extent possible, pre-fabricated components from on-site inventory.

This application is based on Provisional Application #60/879355, filed on Jan. 9, 2007, the priority of which is claimed.

### BACKGROUND

There are currently many techniques in use for the construction of metallic, non-metallic, and hybrid fixed dental restorations and prostheses, requiring custom fabrication of supportive understructure frameworks upon which esthetic veneering materials may be applied to produce lifelike, functional fixed dental prostheses. This is a time-consuming and, therefore, expensive process that requires the utilization of highly trained technicians skilled in the various steps involved in designing, sculpting and processing the elements that must come together to create a dental crown or bridge framework.

In addition, the fabrication of a non-metallic framework requires that the laboratory either makes a large capital investment to obtain the necessary equipment to do the work on-site or is forced to out-source the work to a commercial laboratory, causing delay, and reducing both control over the work and profit from it.

Thus, there exists a need to provide a system for the production of non-metallic crown and bridge understructures utilizing, to the greatest extent possible, prefabricated components from on-site inventory.

### SUMMARY

This is a system of prefabricated components of various materials that are physically, chemically and structurally compatible with one another and with various esthetic veneering materials used in the fabrication of fixed dental restorative and prosthetic devices.

The physical forms of the components are determined by their application and include, without being limited to, Specific Abutment Copings, Universal Coping Caps and Universal Interlocking Connecting Bars of various lengths.

A Specific Abutment Coping is manufactured to fit a particular implant abutment. A different Specific Abutment Coping is required for each different shape of implant abutment manufactured for use with cementable restorations. A variant of the Specific Abutment Coping can be custom-fabricated to fit a prepared natural tooth, broadening the applicability of the system. Atop each Specific Abutment Coping is a standardized cylindrical Pinnacle that inserts into the matched receptacle in the underside of the Universal Coping Cap. The height of the Coping Cap is vertically adjustable to conform to the amount of clearance between the abutment and the opposing tooth.

The receptacle on the underside of the Universal Coping Cap is designed to receive the Pinnacle of a Specific Abutment Coping, creating a platform to which Universal Interlocking Connecting Bars can attach on either side. An assembly can connect to another assembly by virtue of the interlocking capability of the Universal Interlocking Connecting Bars, to create a framework “bridge” between implants. Chains of assemblies can conform to the dental arch through the use of Universal Coping Caps of differing angular relationships of their bar attachment locations, or, where only slight arch curvature exists, through the flexibility inherent in the ball-joint Cap/Bar connection. Alternately, the receptacle on the underside of the Universal Coping Cap can receive the Pinnacle of a Specific Abutment Coping, to create a support structure to receive esthetic veneering materials in order to make a single crown.

### BRIEF DESCRIPTION OF DRAWINGS

Please note that hereafter, the three main elements of the present invention,

The Specific Abutment Coping (20),

The Universal Coping Cap (30), and

The Universal Interlocking Connecting Bar (40), shall be referred to as “Coping,” “Cap,” and “Bar,” respectively, and the Dental Implant Bridge Framework of the present invention shall be referred to as the “Framework.”

FIG. 1a is a lateral view of the assembled Framework consisting of two interlocked Coping-Cap-Bar assemblies, fully retracted, the first embodiment of the present invention.

FIG. 1b is a superior view of the assembled Framework consisting of two said interlocked Coping-Cap-Bar assemblies, fully retracted, the first embodiment of the present invention.

FIG. 1c is a lateral view of the assembled Framework consisting of two said interlocked Coping-Cap-Bar assemblies, fully extended, the second embodiment of the present invention.

FIG. 1d is a superior view of the assembled Framework consisting of two said interlocked Coping-Cap-Bar assemblies, fully extended, the second embodiment of the present invention.

FIG. 2a is lateral view of the current embodiment of the Coping of the present invention.

FIG. 2b is a superior view of the current embodiment of said Coping of the present invention.

FIG. 2c is an inferior view of the current embodiment of said Coping of the present invention.

FIG. 2d is a supero-lateral view of the current embodiment of said Coping of the present invention.

FIG. 2e is a supero-lateral view of one of many alternate embodiments of said Coping of the present invention.

FIG. 3a is a lateral view of the current embodiment of the Cap of the present invention.

FIG. 3b is a superior view of the current embodiment of said Cap of the present invention.

FIG. 3c is an anterior (or posterior) end-view of the current embodiment of said Cap of the present invention.

FIG. 3d is an antero- (or postero-) supero-lateral view of the current embodiment of said Cap of the present invention.

FIG. 3e is an antero- (or postero-) infero-lateral view of the current embodiment of said Cap of the present invention.

FIG. 4a is a lateral view of the Bar of the current embodiment of the present invention.

FIG. 4b is a superior view of said Bar of the current embodiment of the present invention.

FIG. 4c is an interlock-end view of said Bar of the current embodiment of the present invention.

FIG. 4d is a ball attachment-end view of said Bar of the current embodiment of the present invention.

FIG. 4e is a supero-medial view of the attachment end of said Bar of the current embodiment of the present invention.

FIG. 4f is a supero-medial view of the interlock end of said of the current embodiment of the present invention.

### DETAILED DESCRIPTION

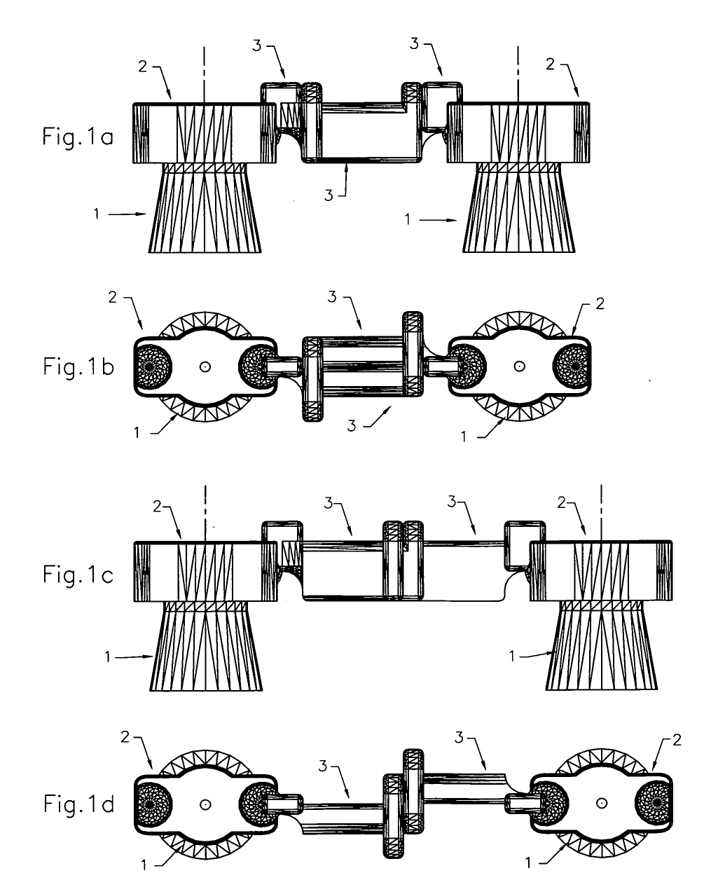

Referring to FIGS. 1a and 1b, an assembled Dental Implant Bridge Framework of the first embodiment of the present invention includes two Copings (20), two Caps (30), and two Bars (40). Said Framework fits the exact distance between implant abutments through the selection of the appropriate length Bars, maximizing Bar-Bar overlap contact area.

As shown in FIGS. 1a, 1b, 1c, and 1d, said Framework is capable of conforming to a variety of inter-abutment geometric relationships through a ball-socket joint consisting of the female ball socket (34) of said Cap and the ball portions (43) of said Bars.

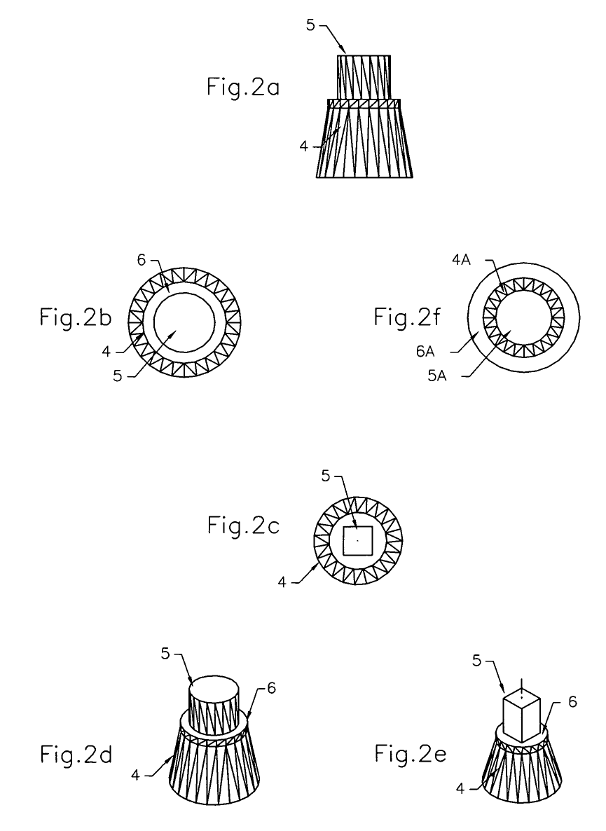

Referring to FIGS. 2a, 2b and 2c, said Coping consists of an internal body portion (21), an external coping body portion (22), a pinnacle portion (23), and a horizontal shoulder portion (24). While said pinnacle portion conforms to one of several sets of standardized dimensions, said internal body portions correspond to one of several sets of standardized dimensions, each specific to a different dental implant system and set of applications.

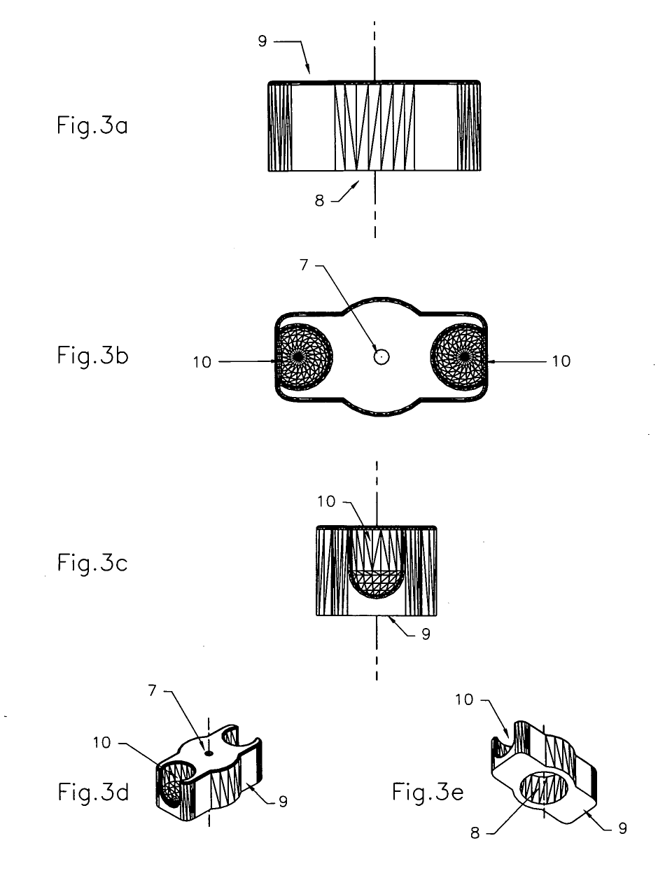

Referring to FIGS. 3a, 3b, 3c, 3d, and 3e, said Cap contains a vent hole (31), a pinnacle receptacle (32), a ball-socket support (33), and two female ball sockets (34). The said pinnacle receptacle of said Cap conforms to one of several possible sets of standardized dimensions incorporated into said pinnacle of said Coping. Please note in FIGS. 3a, 3b, and 3c, that a vent hole exists in the solid top of said Cap, which may vary in diameter depending upon the materials used and the processing techniques employed.

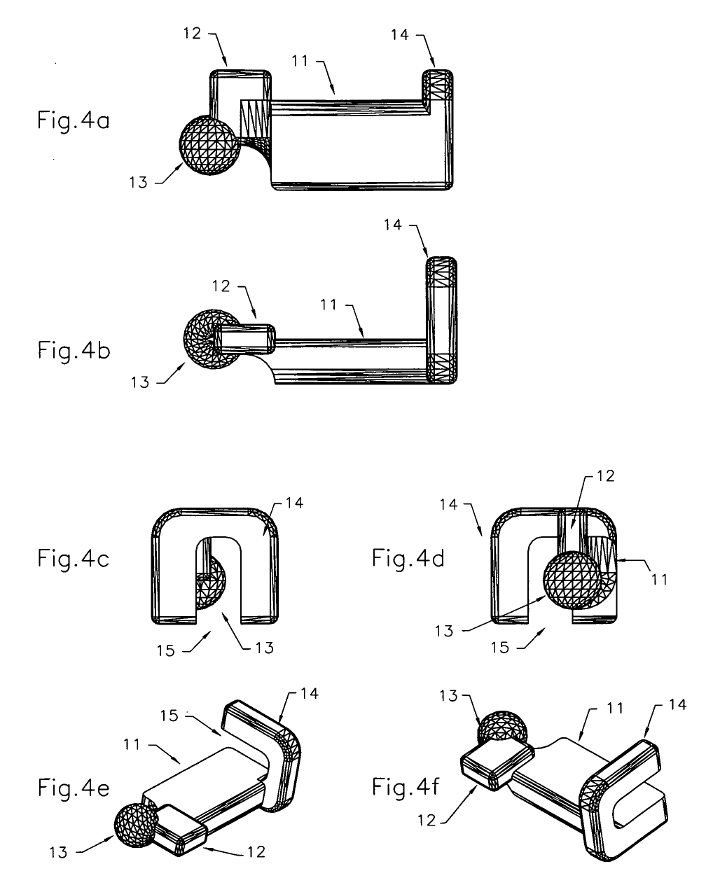

As shown in FIGS. 4a, 4b, 4c, 4d, 4e and 4f, said Bar consists of the body of the bar (41), the bar-ball connector (42), the said ball portion (43) of said Bar-Cap ball-socket joint. The bar interlocking element (44), holds said Bars together (FIGS. 1a and 1b) in close apposition in the final Framework. The appropriate length of the interlocked Bars is achieved by sliding the ball portions closer together or further apart through the access cutouts (45) of said bar interlocking elements.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the current patent application.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1) A system of prefabricated components of various materials that are physically, chemically and structurally compatible with one another and with various esthetic veneering materials used in the fabrication of fixed dental restorative and prosthetic devices, the forms of which are determined by their application, comprising, without being limited to:
Specific Abutment Copings prefabricated to fit specific dental implant abutment designs from a variety of implant manufacturers;
Universal Coping Caps which are vertically adjustable, to conform to the amount of clearance between the abutment and the opposing tooth;
Universal Interlocking Connecting Bars of various lengths

2) The apparatus as specified in claim 1
wherein the use of prefabricated parts to fit a specific dental implant abutment, broadens the applicability of the system as follows:
A different Specific Abutment Coping for each implant abutment of cementable design, from a number of different implant manufacturers, and the Pinnacle of the Specific Abutment Coping, mating to the Universal Coping Cap, allows broad application in the field of implant dentistry.

3) The apparatus as specified in claim 2
wherein the height of the said Universal Coping Cap is vertically adjustable to conform to the amount of clearance between the said abutment and the opposing tooth;

4) The assembly in claim 3
further connects, by virtue of interlocking action, with the said Universal Interlocking Connecting Bars, to create a framework “bridge” between implants.

5) The assembly in claim 4, further comprising
chains of assemblies conforming to the dental arch through the use of Universal Coping Caps of differing angular relationships of their bar attachment locations, or, where only slight arch curvature exists, through the flexibility inherent in the ball-joint Cap/Bar connection.

6) The assembly in claim 5 further adjusts as follows:
the receptacle on the underside of the said Universal Coping Cap is designed to receive said Pinnacle of a Specific Abutment Coping, to create a platform (to receive esthetic veneering materials in order to make an esthetic abutment crown) to which Universal Interlocking Connecting Bars can attach to either side.

7) The assembly of claim 6
can, by virtue of the interlocking capability of the said Universal Interlocking Connecting Bars, create a stabile “bridge” framework between implants.
